(19) United States
(12) Patent Application Publication
(10) Pub. No.: US 2021/0235730 A1
(43) Pub. Date: Aug. 5, 2021

(54) FOOD PROTECTION OF FRUIT, CEREAL AND VEGETABLE AND DERIVATIVES

(71) Applicant: Hawei Technologies Co., Ltd., Shenzhen (CN)

(72) Inventor: Dilek UCAR, Cesme/Izmir (TR)

(21) Appl. No.: 17/045,389

(22) PCT Filed: Apr. 7, 2018
(86) PCT No.: PCT/TR2018/050151

§ 371 Date: Oct. 5, 2020

(51) Int. Cl. A23L 3/3526; A23L 2/44; A23B 7/155; A23L 2/02; A23L 3/3571; A23L 3/3544; A23L 3/3472; A23B 9/28; A21D 15/08

(52) U.S. Cl. CPC A23L 3/3526; A23L 2/44; A23B 7/155; A23L 2/02; A23V 2002/00; A23L 3/3544; A23L 3/3472; A23B 9/28; A21D 15/08; A23L 3/3571

(57) ABSTRACT

Food protecting agent composition having a pH of between 5.5 and 7.5 containing at least 2000 mg/l, preferably at least 1800 mg/l of a combination food protecting agent and guanidinium derivatives, particularly to combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts.

The purpose of any pre-harvest plant protection program for fruit, cutflowers and vegetables (fruit and vegetables are selected from cereals, e.g. wheat, barley, rye, oats, rice, sorghum and the like; beets, e.g. sugar beet and fodder beet; pome and stone fruit and berries, e.g. apples, pears, plums, peaches, almonds, cherries, strawberries, raspberries and blackber leguminous plants, e.g. beans, lentils, peas, soy beans; oleaginous plants, e.g. rape, mustard, poppy, olive, sunflower, coconut, castor-oil plant, cocoa, ground-nuts; cucurbitaceae, e.g. pumpkins, gherkins, melons, cucumbers, squashes; fibrous plants, e.g. cotton, flax, hemp, jute; citrus fruit, e.g. orange, lemon, grapefruit, mandarin; tropical fruit, e.g. papaya, passion fruit, mango, carambola, pineapple, banana; vegetables, e.g. spinach, lettuce, asparagus, brassicaceae such as cabbages and turnips, carrots, onions, tomatoes, potatoes, hot and sweet peppers; laurel-like plants, e.g. avocado, cinnamon, camphor tree; or plants such as maize, tobacco, nuts, coffee, sugar-cane, tea, grapevines, hops, rubber plants, as well as ornamental plants, e.g. cutflowers, roses, gerbera and flower bulbs, shrubs, deciduous trees and evergreen trees such as conifers) is to prevent the development of diseases that might impair the final quality of the fruit, cutflowers and vegetables and to obtain adequate production yields. The system for post-harvest application of plant protection products on fruit, cutflowers and vegetables during packing aims to safeguard the health of the fruit and vegetables during the period of storage and transport to the final consumer. Since, moreover, the environmental and economic requirements imposed on modern-day fungicides are continually increasing, with regard, for example, to the spectrum of activity, toxicity, selectivity, application rate, formation of residues, and favorable preparation ability, and since, furthermore, there may be problems, for example, with resistances developing to known active compounds, a constant task is to develop new fungicide agents which in some areas at least have advantages over their known counterparts. Therefore, there is still a need to find and/or develop other bacterial, viral and fungicides for storage disease control. Some of the chemical as such are already known. It is also known, that these compounds can be used as more healthy and applicable material.

### FIELD OF THE INVENTION

This invention relates to the field of fruit, cereal and vegetable protecting composition. The present invention relates to a combination guanidinium derivatives, particularly to combinations of oligo(2-(2-ethoxy)ethoxy ethyl guanidinium chloride), poly(hexamethylendiamine guanidinium chloride), enzymes, PGPR, amino acids, antioxidants like humic acids and some natural products like phytotherapeutic plant extracts.

### BACKGROUND OF THE INVENTION

Microbial contamination of food can be a considerable health risk. It may lead to heavy gastro-intestinal disorders and is also the suspected cause of “summer-influenza” which is associated with sickness, emesis, diarrhoea and ague. Harmful microorganisms may also contain or excrete strong poisons which may lead to perilous contamination, for example meat poisoning causing botulism. In certain cases, the microorganism can also be carcinogenic (e.g. from mycotoxins of special moulds).

Food spoilage or food poisoning is usually prevented by a combination of different hurdles (e.g. heating, reduced water activity, chilled distribution, presence of preservatives) which inhibit or completely destroy bacteria, yeast and moulds.

However, preservatives which are legally approved and commonly used may still be harmful to some consumers. For instance, benzoic acid and sorbic acid may cause allergies, while sulphite, sulphurous acid, and sulphur dioxide may have further deleterious effects. The preservatives used in cured meat products may also release carcinogenic compounds when heated over 12° C.

There is thus a tendency to look for harmless alternatives which can be used in food products. Amongst these, spices and/or extracts from various plants or fruits have proven to be effective antimicrobial agents. For instance, Weiss J. et al. in Journal of Food Protection, Vol. 68, No. 12, 2005, p. 2559-2566 and in Journal of Food Protection, vol. 68, No. 7, 2005, p. 1359-1366 describe the antimicrobial effect of essential oil components.

The problem with including these in food products, however, is that the taste of the food product may be altered, or that solubility and thus stability/efficiency issues may arise.

Various publications exist which describe the antibacterial effect of guanidium against food spoilage: The publication refers to the use of guanidin in combination with said organic acid salts against food spoilage rather than to food poisoning with gram negative bacterial pathogens. [0009] JP2001-245644 describes a method of improving a preservable period of a processed food such as processed meats or edible daily dishes by using at least a lactic acid salt and an acetic acid salt. guanidium may be added as necessary. The publication describes that said method is capable of suppressing the growth of microorganisms associated with putrefaction or deterioration. The publication does not refer to any effect of the method on food pathogenic bacteria. One test is described wherein said combination of maltose and glycine is tested against putrefaction of a beef extract medium by Bacillus bacteria. The publication is directed to food spoilage by lactic acid bacteria rather than to food poisoning by gram-negative bacterial pathogens but guanisium base product is much more better this application. Guanidium can be used against food spoilage by “heat resistant indigenous or natural flora which survive the usual cooking or heat treating operation” and further against food poisoning outbreaks by enterotoxigenic microorganisms such as Micrococcus pyogenes or more commonly referred to as Staphylococcus. JP 57-008747 discloses that the addition of guanidium to raw materials for dried noodles has an antibacterial effect on the general group of coliform bacilli, and does not disclose use of guannidium and guanidium derivatives material such as combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts as antibacterial agent in a refrigerated food. Stonsaovapak et al. (Food 30th year Vol. 4 October-December 2000; XP002315133) discloses that glycine affects growth of two E. coli strains in TSB nutrient broth. In addition, the survival of E. coli O157:H7 in three ready to eat foods held at 4° C. is measured, however, without the addition of glycine but guanidium and derivatives produc is most effective.

Another publication describes the use of guanidium against molds and yeast and coliform: International Food Information, prolonging the storage life of foods by non-traditional preservation methods”, Some of the article describes the effect of guanidium on prolonging the storage life of preserved products. Raw pork goulash was used as test product. All samples were processed by heat-treatment. The results show that addition of guanidium has an effect on the growth of moulds and yeasts that are present in raw pork that has subsequently been heat-treated and pasteurised. The part of the microorganisms involving coliform microorganisms and arerobic spore-forming microorganisms is not significantly influenced by the presence of guanidium.

Fruits, cut flowers and vegetables to be treated according to the invention are particularly selected from cereals, e.g. wheat, barley, rye, oats, rice, sorghum and the like; beets, e.g. sugar beet and fodder beet; pome and stone fruit and berries, e.g. apples, pears, plums, peaches, almonds, cherries, strawberries, raspberries and blackber leguminous plants, e.g. beans, lentils, peas, soy beans; oleaginous plants, e.g. rape, mustard, poppy, olive, sunflower, coconut, castor-oil plant, cocoa, ground-nuts; cucurbitaceae, e.g. pumpkins, gherkins, melons, cucumbers, squashes; fibrous plants, e.g. cotton, flax, hemp, jute; citrus fruit, e.g. orange, lemon, grapefruit, mandarin; tropical fruit, e.g. papaya, passion fruit, mango, carambola, pineapple, banana; vegetables, e.g. spinach, lettuce, asparagus, brassicaceae such as cabbages and turnips, carrots, onions, tomatoes, potatoes, hot and sweet peppers; laurel-like plants, e.g. avocado, cinnamon, camphor tree; or plants such as maize, tobacco, nuts, coffee, sugar-cane, tea, grapevines, hops, rubber plants, as well as ornamental plants, e.g. cutflowers, roses, gerbera and flower bulbs, shrubs, deciduous trees and evergreen trees such as conifers. This enumeration of culture plants is given with the purpose of illustrating the invention and not to delimiting it thereto.

Particularly preferred is the treatment of pome and stone fruit and berries, in particular apples, pears, plums, peaches, almonds, cherries, strawberries, raspberries and blackberries. Particularly preferred is the treatment of citrus fruit, in particular orange, lemon, grapefruit, mandarin. Particularly preferred is the treatment of tropical fruit, in particular papaya, passion fruit, mango, carambola, pineapple, banana. Particularly preferred is the treatment of grapevines.

The active compound combinations or compositions according to the invention can be used as such or, depending on their respective physical and/or chemical properties, in the form of their formulations or the use forms prepared therefrom, such as aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspension concentrates, suspo emulsion concentrates, soluble concentrates, suspensions, wettable powders, soluble powders, dusts and granules, water-soluble granules or tablets, water-soluble powders for the treatment of seed, wettable powders, natural products and synthetic substances impregnated with active compound, and also micro encapsulations in polymeric substances and in coating materials for seed, seedling and harvested product and also ULV cold-fogging and warm-fogging formulations.

The active compound combinations according to the invention can be present in (commercial) formulations and in the use forms prepared from these formulations as a mixture with other (known) active compounds, such as insecticides, attractants, sterilants, bactericides, acaricides, nematicides, fungicides, growth regulators, herbicides, fertilizers, safeners and Semiochemicals.

The treatment according to the invention of the plants, plant edible parts, fruit leaves with the active compounds or compositions is carried out directly or by action on their surroundings, habitat or storage space using customary treatment methods, for example by dipping, spraying, atomizing, irrigating, evaporating, dusting, fogging, broadcasting, foaming, painting, spreading-on, watering (drenching), drip irrigating and, in the case of propagation material, in particular in the case of seeds, furthermore as a powder for dry seed treatment a solution for seed treatment, a water-soluble powder for slurry treatment, by incrusting, by coating with one or more layers, etc. It is furthermore possible to apply the active compounds by the ultra-low volume method, or to inject the active compound preparation or the active compound itself into the soil.

The present invention is directed to the use of combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts as antibacterial agent against the gram-negative bacterial and fungie pathogens combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts in refrigerated foods or refrigerated drinks with the proviso that in addition to said guanidium and/or guanidium derivative no hetero-saccharide containing macromolecule is used, nor 1,5-D-anhydrofructose is used as antibacterial agent in said foods. While in some the prior art documents complicated guanidium compounds are mentioned which are stated to have antibacterial properties, the present invention is directed to the use of “simple” guanidium compounds such as combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts. The medium present in real food and food products products comprises proteins and fats, has a specific mobility of the liquids present, adsorption or incorporation of the guanidium in the food product may occur. Without being committed to a theory, it is thought that the fact that guannidium is an amin group and a natural building block of food and food products and is abundantly present in food constituents, causes it to interfere in a rather unpredictable way in real food and food products.

We have found that combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts can effectively be used as a sole antibacterial agent in concentrations that are still acceptable in food and food products without negatively affecting the product quality with respect to for example taste and texture. We have found that combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts can be used as sole antibacterial agent for preservation purposes and further to prevent the consequences of contamination of food and drink products as food poisoning by pathogenic bacteria due to temperature-abuse and/or contamination. It is not needed to add an auxiliary antibacterial agent to achieve the desired preservation effect in contrast to the results described in above-mentioned patents. This results not only in lower material costs but also in a higher product quality. Products are obtained with less auxiliary ingredients added while maintaining and even improving the quality and shelf life of said products. Further, this is in line with legislation that is aimed at minimisation of the use of additives in food applications. Furthermore, the products obtained are also protected against the consequences of temperature-abuse or contamination.

Combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts concentrations of 0.2 to 3 wt % based on total weight of product show antibacterial activity against Salmonella, and in particular Salmonella typhimurium and Salmonella enteriditis. combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts concentrations of 0.2 to 1.5 wt % based on total weight of product were found to be suited in ensuring taste of the product. Tests showed that a concentration of about 1 to 1.8 wt % of combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts based on total weight of product starts to affect the taste of said product. In said product no auxiliary antibacterial agents and no other taste affecting ingredients were present. A combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts concentration above 1.5 wt % based on total weight of the product gives the product a sweet taste. Dependent on the type of product this sweet taste is acceptable or not. In sweet drinks for example the sweetening effect of guanidium is not considered a problem. Accordingly the maximally acceptable combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts concentration in terms of not negatively affecting taste can be increased to concentrations above 1.8 wt % guanidium based on total weight of the product. Further, dependent on the presence of other taste affecting ingredients in the product as for example masking agents, the maximum concentration of combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts can also be increased up to a point at which the taste starts to be negatively affected by the presence of gundium derivative. It was found that the use of guanidium and/or its derivatives according to the invention as antibacterial agent in refrigerated foods and refrigerated drinks may be combined with one or more combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts.

The related art of interest describes various food supplements, but none discloses the present invention. There is a need for a powdered food protecting composition which supplies a variety of nutrients and flavors for enriching and flavoring one's food, but also curbing one's appetite to prevent overeating. The related art will be discussed in the order of perceived relevance to the present invention.

U.S. Pat. No. 5,770,217 issued on Jun. 23, 1998, to Frank J. Kutilek, III et al. describes a dietary pilled supplement comprising herbs, herbal extracts, vitamins, minerals, and amino acids effective in modulating hematological toxicities, enhancing the immune system and maintaining appetite and weight. The supplement contains a large amount of crucifer extract (8-12 wt. %) and ascorbic acid or vitamin C (8-13 wt. %). The amino acids include glutathione, L-cysteine and L-methionine. The composition is distinguishable for requiring crucifer extract and amino acids in pill form.

U.S. Pat. No. 4,348,379 issued on Sep. 7, 1982, to Horst Kowalsky et al. describes a dietetic composition for natural digestion regulation comprising in parts by weight each of 50-150 of whole fleawort seeds, whole linseed, wheat bran, and lactose. A binding agent based on natural rubber and optionally, flavor and/or food color. The composition is distinguishable for requiring fleawort seeds and whole linseed.

U.S. Pat. No. 4,440,760 issued on Apr. 3, 1984, to Rex E. Newnham describes a food supplement for the relief of arthritic conditions comprising in parts by weight of 2-500 of sodium tetraborate, 150 each of the dried herbs Gauaiacum, Berberis and Harpagophytum, 1 ppm Rhus-tox and/or Bryonia, gum arabic as binder, starch as a disintegration aid, and magnesium stearate as a lubricating aid in tablet forming. The composition is distinguishable for requiring sodium tetraborate and several dried herbs not required in the present invention.

U.S. Pat. No. 5,332,579 issued on Jul. 26, 1994, to Anthony J. Umbdenstock describes a nutritional supplement for optimizing cellular health of recovering drug addicts, alcoholics, smokers, etc., comprising: 1,500-15,000 I.U. vitamin A; 5,000-45,000 I.U. Beta-carotene; 33-300 mg. vitamin B1; 50-1,000 mg. vitamin B6; 30-300 mcg. vitamin B12; 20-500 mg. niacin; 100-2,000 mg. niacinamide; 100 mg. vitamin C; 5-100 mg. magnesium; 10-100 mg. zinc; 50-1,000 mg. valerian root; at least two minerals selected from the group consisting of calcium, 20-500 mcg. chromium, copper, iron, 5-1,000 mg. manganese, and selenium; and at least four additional vitamins, herbs, and amino acids selected from the group consisting of 100-1,000 I.U. vitamin D3, 10-800 I.U. vitamin E, 5-100 mg. vitamin B2, 100-1,000 mcg. biotin, 50-500 mg. pantothenic acid, 70-900 mg. choline, 100-1,000 mg. inositol, 50-1,000 mg. glutamic acid, 50-1,000 mg. glutamine, and echinachea. The composition is distinguishable for omitting beans, peas, berries, and grains. U.S. Pat. No. 5,656,312 issued on Aug. 12, 1997, and U.S. Pat. No. 5,834,048 issued on Nov. 10, 1998, to Udo Erasmus et al. describes a daily dietary food supplement composition packaged in a sealed pouch for humans comprising at least by weight proportions, 71-73% flax seeds, 5% yeast, 6% rice and bran yeast, 2% liver, 2% alfalfa, 1% bone, 2% carrot, 2% apple, 0.07% kelp. 0.01% lecithin, 0.01% garlic, 0.02% taurine, 0.01% equiteum herb, and 0.01% carnitine. The composition must be prepared at a temperature below 100° F. for less than 20 minutes and in the limited illumination of red light. The food composition is distinguishable for requiring liver, yeast, flax seeds, garlic, and taurine as well as limited heating and lighting conditions.

U.S. Pat. No. 5,925,377 issued on Jul. 20, 1999, to Teja D. Gerth et al. describes a dietary supplement composition combining amino acids, minerals, herbs, vitamins, diuretics, and digestive enzymes. For example, D,L-phenylalanine is combined with tyrosine, L-glutamine and St. John's wort to act as an appetite depressant while L-carnitine is combined with chromium picolinate to work as fat directors to convert stored body fat into energy. The composition is distinguishable for requiring diuretics and digestive enzymes.

U.S. Pat. No. 5,976,579 issued on Nov. 2, 1999, and U.S. Pat. No. 6,143,332 issued on Nov. 7, 2000, to Linsey McLean describes a nutritional supplement for the prevention and treatment of excessive intestinal permeability comprising at least 50 wt. % nutritional buffers (calcium carbonate), amino acid chelates (selenium, copper, zinc, manganese, iodine, and chromium), minerals, vitamins (A, B-complex, D, and E), antioxidants, free radical scavengers, and intestinal tract-soothing herbs. The composition is distinguishable for requiring buffers, chelates, antioxidants, and free radical scavengers.

U.S. Pat. No. 6,238,672 B1 issued on May 29, 2001, to Jau-Fei Chen describes dietary supplements containing dehydrated cactus fruit juice and ginseng berry juice for food products, drinks, capsules, and tablets. The supplement is distinguishable for requiring cactus fruit juice and ginseng berry juice.

U.S. Pat. No. 6,264,995 issued on Jul. 24, 2001, to Thomas Newmark et al. describes a herbal composition for reducing inflammation in bones and joints comprising holy basil, tumeric, ginger, green tea, rosemary, huzhang, Chinese goldthread, barberry, oregano, and scutellariae baicalensis. The composition is distinguishable for its medicinal characteristics.

U.S. Pat. No. 6,274,189 B1 issued on Aug. 14, 2001, to Massoud Kazemzadeh describes a reduced-flatulence, legume-based snack foods which comprises saccharides depleted legumes (field bean, white pea bean, Tepary bean, Mung bean, lima bean, Broad-bean, chickpea, lentil beans, peanuts, buckwheat, and flax) grain-based ingredients (cereal grain, oil seed, oil seed flour, and mixtures thereof), water, and processing aids (inorganic and organic compounds of calcium, potassium, sodium, and mixtures thereof) processed with a developed matrix having a high crunch texture and a low fat absorption when cooked. The compositions are distinguishable for requiring cooking.

German Patent Application No. DE 31 43 926 A1 published on May 11, 1983, for Kurt Jesselring et al. describes a dietetic composition containing bran and/or pectin, vitamins, minerals, customary auxiliaries and carriers, and an anti-thrombotically active fraction derived from Basidiomycetes such as Auricularia, Himeola auricula judae, Polyporus ovinus, Polyporus giganteus, and Sparassis crispa. The composition is distinguishable for requiring an antithrombotically active fraction.

German Patent Application No. DE 44 16 402 A1 published on Nov. 30, 1995, for Harro Carstens et al. describes an immunity improving food protecting composition comprising ethanolic extra extracts of medicinal herbs (aloe), vegetable oils containing eugenol, and, optionally, conventional stabilizers and additives. The medicinal herb extracts have a detoxifying effect through the stomach and intestinal tract. The composition is distinguishable for requiring only herb extracts, vegetable oils and eugenol.

French Patent Application No. 2 737 849 published on Feb. 21, 1997, for Jean P. Curtay et al. describes an orally administered food supplement for adults over forty years of age comprising: (1) an excipient (gum arabic or starch); (2) mineral salts (calcium carbonate, magnesium carbonate, zinc citrate; (3) vitamins B1, B2, B6, B8, B9, B12, C, E, and PP; (4) beta-carotene, (5) borage oil (herb); (6) fish oil; and (7) methionine. The composition is distinguishable for requiring beta-carotene, borage oil and methionine.

German Patent Application No. DE 196 53 100 A1 published on Jul. 23, 1998, for Adolph Metz describes a lactose-containing magnetic capsule food supplement comprising: (1) ferromagnetic magnetite; (2) piezoelectric rock crystal (silica); (3) magnesite powder (magnesium carbonate); (4) ginseng root, taiga root, mistletoe, ginkgo biloba leaves, hawthorn flowers or leaves, horse chestnut leaves, milk thistle, balm mint leaves, St. John's wort, speedwell, linden flowers, arnica flowers, lesser centaury (Erythraea centaurium), marigold flowers, yarrow (Achillea millefolium), red soapwort, and calamus root; and (5) vitamins A, C, E, aneurin, riboflavin, pyridoxine, B12, and Q10; reduced glutathione, glutamine, cysteine, methionine; (6) Ca-, Mg- and K-citrate; (7) E. Coli or Lactobacillus acidophilus; (8) heartwood of Thuaja plicata; (9) oak bark; (10) aspirin and/or willow bark; (11) zinc, selenium and manganese; and (12) lactose, starch and dextrose. The composition is distinguishable for requiring a vast variety of exotic herbs, vitamins, lactose, minerals, and a magnetic constituent.

W.I.P.O. Patent Application No. WO 98/00024 published on Jan. 8, 1998, and W.I.P.O. Patent Application No. WO 98/47376 published on Oct. 29, 1998, for Houn S. Hsia describes a diet supplement composition to increase the level of high density lipoprotein (HDL) and calcium ions, and to decrease the levels of free radicals and glucose in human blood plasma comprising; (1) anti-oxidants selenium, vitamins A, B, C, D, and E, and fruit or vegetable juice concentrates; (2) green barley composition; (3) tincture of ginkgo biloba extract; and (4) minerals. The composition is distinguishable for requiring minerals, ginkgo biloba, and fruit and vegetable juice concentrates.

German Patent Application No. DE 199 07 586 A1 published on Aug. 24, 2000, for Waldemar Braun et al. describes a daily nutritional composition comprising (a) a basic kit for constant circadian dosage combined with (b) an “add-on” supplement used in time-dependent amounts. The basic kit contains specific amounts of various vitamins and minerals including beta-carotene, vitamins B1, B2, B6, B12, niacin, pantothenic acid, biotin, folic acid, phylloquinone, calcium, magnesium, manganese, zinc, iron, selenium, chromium, molybdenum, copper, and iodine. The “add-on” composition contains apple vinegar powder, artichoke extract, carnitine, guarina, silica, creatine, lecithin, and taurine. The compositions are distinguishable for requiring minerals and the “add-on” composition.

None of the above inventions and patents, taken either singularly or in combination, is seen to describe the instant invention of flavoring and therapeutic effect. Thus, a food protecting composition composition solving the aforementioned problems is desired.

### SUMMARY OF THE INVENTION

The present invention provides protecting agent a combination guanidinium derivatives, particularly to combinations of oligo(2-(2-ethoxy)ethoxy ethyl guanidinium chloride), poly(hexamethylendiamine guanidinium chloride), enzymes, PGPR, amino acids, antioxidants like humic acids and some natural products like phytotherapeutic plant extracts.

The present invention is based in part on the unexpected discovery that oligo (2-(2-ethoxy) ethoxy ethyl guanidinium chloride), poly(hexamethylendiamine guanidiniumchloride), enzymes, PGPR, amino acids, antioxidants like humic acids and some natural products like phytotherapeutic plant extracts show a synergistic inhibiting effect on the proliferation of various cancerous cell types. Without wishing to be bound by any particular theory or mechanism of action this synergistic effect may be attributed to the capability of oligo 2-(2-ethoxy) ethoxy ethyl guanidinium chloride), poly(hexamethylendiamine guanidinium chloride), enzymes, PGPR, amino acids, antioxidants like humic acids and some natural products like phytotherapeutic plant extracts to significantly enhance the therapeutic effect.

The present invention is a food enhancer which curbs one's appetite while simultaneously adding nutritional value and flavor to the food to be eaten. The composition is in powder form that is versatile in application to any food. The food protecting composition can be added to food being cooked, included in appetizers or sprinkled on any food while eating out. It consists of a variety of beans, grains, vitamins, herbs, and spices. Because the food enhancer is taken in powder form, absorption by the body is maximized and it is easier to swallow as opposed to tablets. This composition is intended to replace salt, pepper and other spices.

It is another object of the invention to provide a food protecting material in powder form in addition to liquid form.

### DETAILED DESCRIPTION OF THE INVENTION

The present invention relates to methods for the protection of harvested fruits, cutflowers or vegetables against decay caused by certain storage diseases or disorders expressed in storage conditions, which fruits, cutflowers or vegetables have been treated pre-harvest with combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts.

Food protecting agent composition having a pH of between 5.5 and 7.5 containing at least 2000 mg/l, preferably at least 1800 mg/l of a combination food protecting agent and guanidinium derivatives, particularly to combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts.

The purpose of any pre-harvest plant protection program for fruit, cutflowers and vegetables is to prevent the development of diseases that might impair the final quality of the fruit, cutflowers and vegetables and to obtain adequate production yields. The system for post-harvest application of plant protection products on fruit, cutflowers and vegetables during packing aims to safeguard the health of the fruit and vegetables during the period of storage and transport to the final consumer. Since, moreover, the environmental and economic requirements imposed on modern-day fungicides are continually increasing, with regard, for example, to the spectrum of activity, toxicity, selectivity, application rate, formation of residues, and favorable preparation ability, and since, furthermore, there may be problems, for example, with resistances developing to known active compounds, a constant task is to develop new fungicide agents which in some areas at least have advantages over their known counterparts. Therefore, there is still a need to find and/or develop other bacterial, viral and fungicides for storage disease control. Some of the chemical as such are already known. It is also known, that these compounds can be used as more helaty and appliceable material.

This invention relates to the use of an antibacterial agent against gram-negative bacterial pathogens in foods. Further, said antibacterial agent is in particular used against bacteria and bacteria from the genus Fusarium spp., e.g. Fusarium semitectum, Fusarium moniliforme, Fusarium solani, Fusarium oxysporum; Verticillium spp., e.g. Verticillium theobromae; Nigrospora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Alternaria spp., e.g. Alternaria citri, Alternaria alternata; Phytophthora spp., e.g. Phytophthora citrophthora, Phytophthora fragariae, Phytophthora cactorum, Phytophthora parasitica; Septoria spp., e.g. Septoria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporium spp., e.g. Gloeosporium album, Gloeosporium perennans, Gloeosporium fructi genum, Gloeosporium singulata; Phlyctaena spp., e.g. Phlyctaena vagabunda; Cylindrocarpon spp., e.g. Cylin drocarpon mali; Stemphyllium spp., e.g. Stemphyllium vesicarium; Phacydiopycnis spp., e.g. Phacydiopycnis malirum; Thielaviopsis spp., e.g. Thielaviopsis paradoxy; Aspergillus spp., e.g. Aspergillus niger, Aspergillus carbonarius; Nectria spp., e.g. Nectria galligena; Pezicula spp., Escherichia Coli, Enterobacter sakazakii, Salmonella, pseudomonas, escheria coli, entereobacter aerogenes, coliform, legionalla, and Campylobacter in food. Conventionally, bacterial growth in food is controlled and/or prevented by means of pH regulation, water activity control, addition of quality preserving agents as e.g. nitrite and/or using various processing techniques as for example heat treatment, irradiation or high-pressure treatment. However, when controlling gram negative bacterial pathogens the above-described measures are often either insufficient, undesirable or not suitable for the type of food. For instance, controlling the water activity in products is possible by means of e.g. salt addition. Controlling or preventing bacterial growth in products by means of salt addition however requires high salt concentrations. Some of the study result shows that high concentrations often lead to a loss of taste because the product becomes too salty and not applicable. Further, a too high salt dosage is also not desired with respect to health issues as for example heart and vascular diseases or blood pressure. Furthermore, in protein-containing products as for example mushroom said high salt concentrations may lead to deterioration of the texture of the product. As gram-negative bacterial pathogens and some fungie such as Fusarium semitectum, Fusarium moniliforme, Fusarium solani, Fusarium oxysporum; Verticillium spp., e.g. Verticillium theobromae; Nigrospora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Alternaria spp., e.g. Alternaria citri, Alternaria alternata; Phytophthora spp., e.g. Phytophthora citrophthora, Phytophthora fragariae, Phytophthora cactorum, Phytophthora parasitica; Septoria spp., e.g. Septoria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporium spp., e.g. Gloeosporium album, Gloeosporium perennans, Gloeosporium fructi genum, Gloeosporium singulata; Phlyctaena spp., e.g. Phlyctaena vagabunda; Cylindrocarpon spp., e.g. Cylin drocarpon mali; Stemphyllium spp., e.g. Stemphyllium vesicarium; Phacydiopycnis spp., e.g. Phacydiopycnis malirum; Thielaviopsis spp., e.g. Thielaviopsis paradoxy; Aspergillus spp., e.g. Aspergillus niger, Aspergillus carbonarius; Nectria spp., e.g. Nectria galligena; Pezicula spp., Escherichia Coli, Enterobacter sakazakii, Salmonella, pseudomonas, escheria coli, entereobacter aerogenes, coliform, legionalla, and Campylobacter are notoriously present in protein-containing products such as mushroom, cheese etcetera, controlling the water activity is often not a viable solution. Also pH regulation of the pH as means for controlling bacterial growth can cause loss of taste of the product and/or loss of texture of the product, especially in protein-rich food. Furthermore, some gram-negative pathogenic bacteria are relatively insensitive to acid addition. For instance growth of Campylobacter bacteria and Salmonella bacteria can be stopped at a pH lower than respectively 4.0 and 3.8, which pH is for some food applications undesirable because of its effect on taste, texture and not convenient appliceable methods.

Nitrite is added in cured meat (including poultry and fish) applications for the purpose of preserving product quality. Nitrite is able to stop bacterial growth of some types of bacteria as for example Clostridium. In some cases nitrite is added as colouring agent to maintain a certain colour in the meat product. Due to this colouring effect of nitrite it is not desirable for all meat applications. Examples of uncured, not nitrite-containing, product applications are (German) sausages, chicken and turkey meat and roast beef. As mentioned above, especially gram-negative bacterial pathogens are often present in these food products. At present legislation is aimed at minimisation of the use of nitrite in food applications. It goes without saying that processing techniques as for example heat treatment, irradiation or high-pressure treatment as method for preservation of products is not always applicable to food applications such as salads and other vegetable products due to processing spreed, costs, consumer preference and influence on the texture and/or taste.

Thus, said above-mentioned methods of salt addition, pH regulation, nitrite addition and processing techniques as e.g. heat treatment are not always satisfactory for the purpose of preservation of foods, especially when controlling gram-negative bacterial pathogens. Accordingly, the preservation of protein-containing food products, pH sensitive food products and refrigerated food products such salads and other vegetable products, dried foods and convenient foods as e.g. ready-to-eat meals, and especially mushroom products still proves to be a problem, especially if the food product needs to be protected against food poisoning as consequences of e.g. temperature-abuse and/or contamination of food. It is known that one of the most important causes of food poisoning is contamination due to incorrect handling of food products. Furthermore, products are often stored at improper conditions. Temperature-abuse (e.g. incidental storage at high temperature) can cause the in the product already present but inactivated bacteria to grow again resulting in food poisoning by pathogenic bacteria. The invention provides an effective alternative to overcome the above-mentioned problems in preservation of foods against food poisoning and further provides a means for fighting food poisoning by pathogenic bacteria of food and products due to e.g. temperature-abuse and/or contamination due to e.g. improper handling and/or improper preparation. It is known that combinations of oligo(2-(2-ethoxy)ethoxy ethyl guanidinium chloride), poly(hexamethylendiamine guanidinium chloride), polyetheramines, triethyleneglycol diamine, enzymes, PGPR, amino acids, antioxidants such as humic acids and some natural products like phytotherapeutic plant extracts can be used to prevent growth of bacteria which cause food spoilage, also called putrefaction. Normally these are lactic acid bacteria, i.e. gram-positive bacteria. When food is spoiled, the taste and/or its appearance is affected, but the consumers health is not at stake. The present invention, however, is directed to the prevention of food poisoning. Food poisoning is caused by gram-negative bacterial pathogens and fungie such as Fusarium semitectum, Fusarium moniliforme, Fusarium solani, Fusarium oxysporum; Verticillium spp., e.g. Verticillium theobromae; Nigrospora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Alternaria spp., e.g. Alternaria citri, Alternaria alternata; Phytophthora spp., e.g. Phytophthora citrophthora, Phytophthora fragariae, Phytophthora cactorum, Phytophthora parasitica; Septoria spp., e.g. Septoria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporium spp., e.g. Gloeosporium album, Gloeosporium perennans, Gloeosporium fructi genum, Gloeosporium singulata; Phlyctaena spp., e.g. Phlyctaena vagabunda; Cylindrocarpon spp., e.g. Cylin drocarpon mali; Stemphyllium spp., e.g. Stemphyllium vesicarium; Phacydiopycnis spp., e.g. Phacydiopycnis malirum; Thielaviopsis spp., e.g. Thielaviopsis paradoxy; Aspergillus spp., e.g. Aspergillus niger, Aspergillus carbonarius; Nectria spp., e.g. Nectria galligena; Pezicula spp., Escherichia Coli, Enterobacter sakazakii, Salmonella, pseudomonas, escheria coli, entereobacter aerogenes, coliform, legionalla, and Campylobacter was said that pathogens produce toxine and/or cause infections.

1. Food protecting agent composition characterised in that it contains at least 2000 mg/l, preferably at least 1500 mg/l, more preferably at least 1000 mg/l, even of a combination guanidinium derivatives, particularly to combinations of oligo(2-(2-ethoxy)ethoxy ethyl guanidinium chloride), poly(hexamethylendiamine guanidinium chloride), enzymes, PGPR, amino acids, antioxidants such as humic acids and some natural products like phytotherapeutic plant extracts.

2. The composition according to claim 1, wherein the guaninidium compound is oligo(2-(2-ethoxy)ethoxy ethyl guanidinium chloride).

3. The composition according to claim 1, wherein the guaninidium compound is poly(hexamethylendiamine guanidiniumchloride).

4. Fruit, cereal and vegetable protecting composition according to claim 1 characterised in that it has a pH of between 5.5 and 7.5.

5. Fruit, cereal and vegetable protecting composition according to claim 2 characterised in that it is selected within the group consisting in plant, and plant products and derivatives such as bread, beverages, fruit, cereal, vegetable brine, fruit and vegetable preserves.

6. Fruit, cereal and vegetable protecting composition according to claim 3 characterised in that the food product is a bread.

7. Fruit, cereal and vegetable protecting composition according to claim 3 characterised in that the food product is a beverage.

8. Fruit, cereal and vegetable protecting composition according to claim 3 characterised in that the food product is vegetable and vegetable brein and preserves.

9. Fruit, cereal and vegetable protecting composition according to claim 3 characterised in that the food product is mushroom.

10. Fruit, cereal and vegetable protecting composition according to claim 3 characterised in that the food product is dry vegetable and fruit.

11. Food protecting composition according to claim 3 characterised in that the food product is fruit and vegetable juice.

12. Food protecting composition according to claim 3 characterised in that the food product is food protecting composition.

13. The composition of claim 1, wherein the food protecting composition is a PGPR, Plant Growth Promoting Rhizobacteria, said biological agent is an antibody selected from the group consisting of Acinetobacter, Achromobacter, Aereobacter, Agrobacterium, Alcaligenes, Artrobacter, Azospirillum, Serratia, Bacillus, Burkholderia, Enterobacter, Erwinia, Flavobacterium, Microccocus, Pseudomonas, Rhizobium ve Xanthomonas.

14. The composition of claim 1, wherein the antioxidant is humic acid leached from leonardite ore and its sodium/potassium salts.

15. The composition of claim 1, wherein amino acids are from a group of L-cysteine, and L-arginine.

16. The composition of claim 1, wherein enzymes are from a group glutaminase, Arginine decarboxylase, histidine decarboxylase (Lactobacillus), and carboxypeptidase.

17. The method of claim 1, wherein herbal plants are Aniseed (Anisi fructus), Barbados Aloes (Aloe barbadensis), Bearberry leaf (Uvae ursi folium), Bilberry Fruit (Myrtilli fructus), Birch Leaf (Betulae folium), Black Cohosh (Cimicifugae rhizoma), Black Currant Leaf (Ribis nigri folium), Black Horehound (Ballotae nigrae herba), Bogbean leaf (Menyanthidis trifoliatae folium), Burdock Root (Arctii radix), Butcher's Broom (Rusci rhizome), Cape Aloes (Aloe capensis), Cascara (Rhamni purshianae cortex), Centaury(Centaurii herba), Clove oil (Caryophylli aetheroleum), Cola (Colae semen), Comfrey root (Symphyti radix), Couch Grass Rhizome (Graminis rhizoma), Elder flower (Sambuci flos), Feverfew (Tanaceti parthenii herba), Frangula Bark (Frangulae cortex), Gentian Root (Gentianae radix), Grindelia (Grindeliae herba), Hamamelis bark (Hamamelidis cortex), Hamamelis leaf (Hamamelidis folium), Hamamelis water (Hamamelidis aqua), Hydrastis rhizoma (Goldenseal rhizome), Ispaghula Husk (Plantaginis ovatae testa), Java Tea (Orthosiphonis folium), Lady's Mantle (Alchemillae herba), Linseed (Lini semen), Mallow Flower (Malvae flos), Meadowsweet (Filipendulae ulmariae herba), Melissa leaf (Melissae folium), Myrrh (Myrrha), Mullein flower (Verbasci flos), Nettle Root (Urticae radix), Pelargonium Root (Pelargonii radix), Psyllium Seed (Psylli semen), Restharrow Root (Ononidis radix), Rhatany Root (Ratanhiae radix), Ribwort Plantain leaf/herb (Plantaginis lanceolatae folium/herba), Sage Leaf, Trilobed (Salviae trilobae folium), Tormentil (Tormentillae rhizoma), White Horehound (Marrubii herbal), Wild Pansy (Violae herba cum flore), Wild Thyme (Serpylli herba), Willow Bark (Salicis cortex).

18. The composition of claim 1, wherein natural products are polyphenols such as EGCG, resveratrol, curcumin, and genistein.

19. The composition of claim 1, wherein it contains cephamine and dopamine.

20. The composition of claim 1, wherein it contains cyclic oligosaccharide, preferably β-cyclodextrin or γ-cyclodextrin.

21. The composition of claim 1, wherein it contains the vitamins or a group of them, preferably Vitamin A, C, and D.

22. The composition of claim 1, characterized in that diseases are caused by Fusarium semitectum, Fusarium moniliforme, Fusarium solani, Fusarium oxysporum; Verticillium spp., e.g. Verticillium theobromae; Nigrospora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Alternaria spp., e.g. Alternaria citri, Alternaria alternata; Phytophthora spp., e.g. Phytophthora citrophthora, Phytophthora fragariae, Phytophthora cactorum, Phytophthora parasitica; Septoria spp., e.g. Septoria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporium spp., e.g. Gloeosporium album, Gloeosporium perennans, Gloeosporium fructi genum, Gloeosporium singulata; Phlyctaena spp., e.g. Phlyctaena vagabunda; Cylindrocarpon spp., e.g. Cylin drocarpon mali; Stemphyllium spp., e.g. Stemphyllium vesicarium; Phacydiopycnis spp., e.g. Phacydiopycnis malirum; Thielaviopsis spp., e.g. Thielaviopsis paradoxy; Aspergillus spp., e.g. Aspergillus niger, Aspergillus carbonarius; Nectria spp., e.g. Nectria galligena; Pezicula spp., Escherichia Coli, Enterobacter sakazakii, Salmonella, pseudomonas, escheria coli, entereobacter aerogenes, coliform, legionalla, and Campylobacter.

23. The composition of claim 1 characterized in that fruit and vegetables are selected from cereals, e.g. wheat, barley, rye, oats, rice, sorghum and the like; beets, e.g. sugar beet and fodder beet; pome and stone fruit and berries, e.g. apples, pears, plums, peaches, almonds, cherries, strawberries, raspberries and blackber leguminous plants, e.g. beans, lentils, peas, soy beans; oleaginous plants, e.g. rape, mustard, poppy, olive, sunflower, coconut, castor-oil plant, cocoa, ground-nuts; cucurbitaceae, e.g. pumpkins, gherkins, melons, cucumbers, squashes; fibrous plants, e.g. cotton, flax, hemp, jute; citrus fruit, e.g. orange, lemon, grapefruit, mandarin; tropical fruit, e.g. papaya, passion fruit, mango, carambola, pineapple, banana; vegetables, e.g. spinach, lettuce, asparagus, brassicaceae such as cabbages and turnips, carrots, onions, tomatoes, potatoes, hot and sweet peppers; laurel-like plants, e.g. avocado, cinnamon, camphor tree; or plants such as maize, tobacco, nuts, coffee, sugar-cane, tea, grapevines, hops, rubber plants, as well as ornamental plants, e.g. cutflowers, roses, gerbera and flower bulbs, shrubs, deciduous trees and evergreen trees such as conifers.
